(19) United States
(12) Patent Application Publication
(10) Pub. No.: US 2003/0236047 A1
(43) Pub. Date: Dec. 25, 2003

(54) Chemical protective composite substrate and method of producing same

(75) Inventor: Seshadri S. Ramkumar, Lubbock, TX (US)

Correspondence Address: THOMPSON & KNIGHT L.L.P., PATENT PROSECUTION DEPARTMENT, 98 SAN JACINTO BLVD., SUITE 1200, AUSTIN, TX, 78701, US

(73) Assignee: Texas Tech University

(21) Appl. No.: 10/235,303

(22) Filed: Sep. 5, 2002

Related U.S. Application Data
(60) Provisional application No. 60/388,536, filed on Jun. 13, 2002.

(51) Int. Cl. B32B 5/26; B32B 5/16; D04H 1/00

(52) U.S. Cl. 442/340; 442/327; 442/346; 442/417

(57) ABSTRACT

A method of producing a chemical protective composite substrate by embedding chemical adsorbent layer between two nonwoven needlepunched substrates. The substrate in woven form is sandwiched between two needlepunched nonwoven mats. The nonwoven mats, in the preferred embodiment, are made from apparel grade polyester fibers of 1.5″ length and 1.5 denier, using H1 technology needlepunching machinery. A woven activated carbon cloth is sandwiched between two nonwoven substrates. The nonwoven substrates are double punched at a speed of 800 strokes/min. The three layers are fed to the conveyor belt that feeds the needleloom. The three-layer sandwich passes through the needling zone and gets compacted into a composite substrate. The three layers are needlepunched at 800 strokes/min resulting in a needle composite structure that has: a top or prefilter nonwoven layer; a middle or adsorbent layer and a bottom or base nonwoven layer. The adsorbent layer can alternatively be woven, nanowebs, fibers or any form that is suitable to be fed through the conveyor of the needleloom.

### CROSS-REFERENCE TO OTHER APPLICATION

This application claims priority from U.S. Provisional Patent Application No. 60/388,536, filed Jun. 13, 2002, which is hereby incorporated by reference.

### TECHNICAL FIELD

The present application relates to an improved protective material and fabric. More particularly, the present application relates to an improved chemical protective composite substrate and an improved method for producing a protective material and fabric.

### DESCRIPTION OF THE RELATED ART

In particular situations people may encounter harmful concentrations of hazardous chemicals. In such situations, it is necessary to wear chemical protective garments of special composition and construction. These protective garments are necessary for providing an effective barrier between the wearer and the chemicals encountered. Protective clothing of many types are well known for many and varied uses including protection from fire, chemical liquids and vapors and other harmful substances. Such clothing is often seen in suits for industrial workers, firemen, hazardous waste workers, chemical workers, race car drivers, airplane pilots and military personnel. Garments include not only complete hermetic suits, but also individual components such as trousers, jackets, gloves, boots, hats, head coverings, masks, etc.

Regulations restricting exposure to hazardous environments of various kinds, such as those contained in the Occupational Safety and Health Act, (OSHA) make it increasingly necessary to have better and more effective kinds of protective clothing.

Protective garments include woven and non-woven fabrics for disposable use. These garments are generally formed from various polymeric films or laminated plastic materials which are intrinsically resistant to dust or liquid penetration and in some cases impervious to chemical vapor penetration. The fabrics are generally spunbonded, meltspun or of non-woven thermoplastic material.

The garments presently available are almost invariably of thick construction and heavy in weight, and are often fabricated at least in part from materials impermeable to water or water vapor, such as natural and synthetic rubbers and elastomers, chlorinated rubbers, etc.

Strong, lightweight chemical protective garment materials made from laminates of different materials are known. U.S. Pat. No. 4,272,851 (Goldstein) describes a film of polyethylene that may be laminated to nonwoven chemical protective apparel. U.S. Pat. No. 4,772,510 (Mc Clure) describes a chemical barrier film laminated to a nonwoven substrate using an adhesive. Other laminates having multiple barrier layers are described in U.S. Pat. Nos. 4,855,178 (Langley); 4,833,010 (Langley) and U.S. Pat. No. 5,035,941 (Blackburn).

Often, each layer of a chemical protective garment material is chosen to impart a specific property to the composite fabric. Some layers provide strength while other layers may be chosen to provide permeation resistance against specific classes of chemicals. Additional layers add weight and stiffness. However, stiff garments are difficult to assemble and reduce the wearer's mobility.

Clearly, what is needed is a lightweight, chemical protective garment material, having a limited number of distinct layers, which can be assembled into a protective garment. In addition, the applicant recognizes the need for simplified processes to make such chemical protective garment materials.

### SUMMARY OF THE INVENTION

It is therefore one object of the present invention to provide an improved protective material and fabric.

It is another object of the present invention to provide an improved chemical protective composite substrate.

It is yet another object of the invention to provide an improved method for producing a protective material and fabric.

The foregoing objects are achieved as is now described. The preferred embodiment provides a simple method of producing a chemical protective composite substrate by embedding chemical adsorbent layer between two nonwoven needlepunched substrates. The substrate in woven form is sandwiched between two needlepunched nonwoven mats. The nonwoven mats, in the preferred embodiment, are made from apparel grade polyester fibers of 1.5″ length and 1.5 denier, using H1 technology needlepunching machinery. A woven activated carbon cloth is sandwiched between two nonwoven substrates. The nonwoven substrates are double punched at a speed of 800 strokes/min. The three layers are fed to the conveyor belt that feeds the needleloom. The three-layer sandwich passes through the needling zone and gets compacted into a composite substrate. The three layers are needlepunched at 800 strokes/min resulting in a needle composite structure that has: a top or prefilter nonwoven layer; a middle or adsorbent layer and a bottom or base nonwoven layer. The adsorbent layer can alternatively be woven, nanowebs, fibers or any form that is suitable to be fed through the conveyor of the needleloom. Other types of apparel grade fibers can also be used to develop nonwoven mats. These include fibers such as nylon, wool, cotton, polypropylene, etc. In addition, exotic and high performance fibers such as mohair, alpaca, aramids, high density polyethylene can also be used to develop a variety of nonwoven base substrates for different end-use applications.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of illustrative sample embodiments when read in conjunction with the accompanying drawings, wherein:

FIG. 1 depicts a three-layered composite substrate according to the preferred embodiment, and produced by a method according to the preferred embodiment;

FIGS. 2A and 2B show charts of a load/elongation curves of the composite substrate of the preferred embodiment, in a cross-direction and machine-direction, respectively;

FIGS. 3A and 3B show charts of a bursting strength curves of the composite substrate of the preferred embodiment, in a machine-direction and cross-direction, respectively;

FIG. 4 shows a sliding friction apparatus used to take surface friction measurements of the preferred composite substrate;

FIGS. 5A and 5B show charts of a friction force versus normal load relationship curves of the composite substrate of the preferred embodiment, in a cross-direction and machine-direction, respectively;

### DETAILED DESCRIPTION OF THE PREFERRED EMBODIMENTS

The numerous innovative teachings of the present application will be described with particular reference to the presently preferred embodiment (by way of example, and not of limitation).

The preferred embodiment provides a new and simple method of embedding chemical adsorbent layer between two nonwoven needlepunched substrates. The substrate in woven form is sandwiched between two needlepunched nonwoven mats. The nonwoven mats, in the preferred embodiment, are made from apparel grade polyester fibers of 1.5″ length and 1.5 denier, using H1 technology needlepunching machinery. A woven activated carbon cloth is sandwiched between two nonwoven substrates. The nonwoven substrates are double punched at a speed of 800 strokes/min. The three layers are fed to the conveyor belt that feeds the needleloom. The three-layer sandwich passes through the needling zone and gets compacted into a composite substrate. The three layers are needlepunched at 800 strokes/min resulting in a needle composite structure that has: a top or prefilter nonwoven layer; a middle or adsorbent layer and a bottom or base nonwoven layer.

According to various embodiments of the present invention, the adsorbent layer can be woven, nanowebs, fibers or any form that is suitable to be fed through the conveyor of the needleloom.

The claimed composite offers protection against toxic chemicals due to the activated carbon layer and provides necessary comfort and breathability to the wearers.

In the preferred process, regular apparel grade polyester fibers of 1.5″ length and 1.5 denier are used as the pre-filter and base substrates. Preferably, Dacron® fibers are used; Dacron® is a long-chain polyester made from ethylene glycol and terephthalic acid and manufactured by DuPont. The polyester fibers are passed through a double cylinder card and a crosslapper machine before being fed into an Hi technology needleloom machine. The speed of punching is preferably 800 needle strokes/min, and the weights of the pre-filter and base substrates are 43.8 g/m².

The principle of the Hi technology used in the preferred embodiment is the special properties that can be obtained by oblique angled needle penetration. This unique capability is achieved by means of an asymmetrically curved needling zone, accompanied by a straight needle movement. Because of this design, some fibers are punched or inserted at an angle rather than in a vertical direction. The advantages of this technology include the following:

1. The longer needle path results in better fiber orientation and fiber entanglement than the conventional needle machine.

2. Superior web properties can be obtained with fewer needle penetrations.

3. It greatly enhances the construction of composite and hybrid products.

4. It delivers increased productivity versus conventional needlepunch looms.

The H1 processing line includes units for complete processing, from bale to finished fabric. A Tatham Card fitted with a three-roller/seven-roller design is fed by a Tatham Single Automatic Feeder Model 503; this latter unit is equipped with a volumetric delivery system. A Microfeed 2000 unit is included in the line to monitor the fiber delivery from the chute section of the volumetric hopper and to speed of the card feed rollers; this compensates for any discrepancy between the pre-programmed “target” weight and the continuously monitored “actual” weight. Thus, the Microfeed unit ensures extremely accurate fiber delivery into the card unit. The web from the card is delivered from the single doffer section of the card to a Tatham conventional design crosslapper. The line is equipped with an AC Inverter-controlled drive system.

The composite substrate consists of 3 layers:

1. Prefilter layer, which in the preferred embodiment is a Dacron nonwoven fabric;

2. Adsorption layer, which in the preferred embodiment is an activated carbon woven fabric;

3. Base/Next-to-skin layer, which in the preferred embodiment is a Dacron nonwoven fabric.

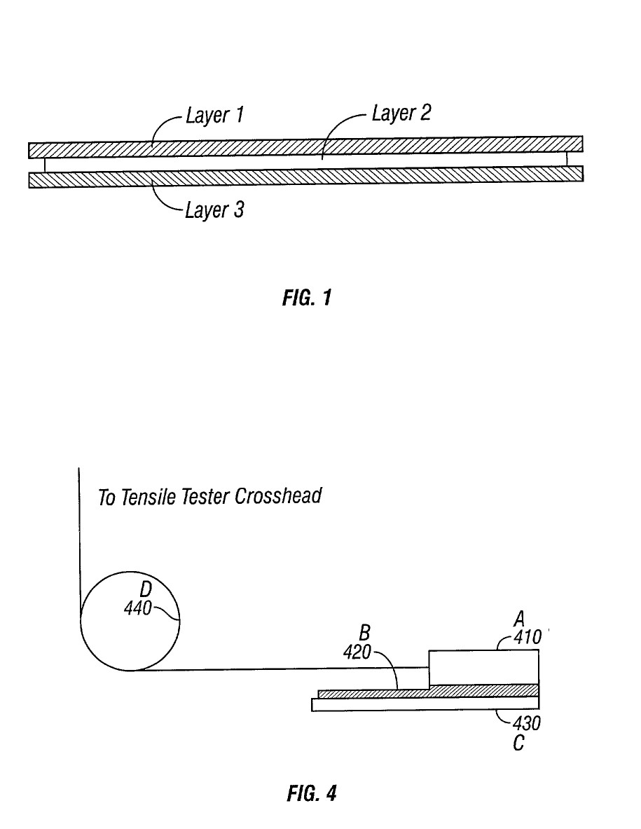

These 3 layers are needlepunched to develop the composite substrate at 800 strokes/min. The activated carbon fabric in the preferred embodiment is obtained from American Kynol, Inc. Based on the visual observation, the composite substrate was found to be regular and uniform. The three-layer composite is pictorially depicted in FIG. 1.

Layer 1: Needlepunched layer: Double punched Dacron nonwoven (43.2 g/m²).

Layer 2: Middle layer: Plain weave activated carbon woven fabric (120 g/m²).

Layer 3: Needlepunched layer: Double punched Dacron nonwoven (43.2 g/m²).

Important physical characteristics such as 1) weight, 2) tensile strength, 3) tear strength and 4) bursting strength were evaluated using standard ASTM test methods. In addition, the surface mechanical property was measured using a sliding friction apparatus.

Weight of the Composite Fabric

Table 1 gives the weight of the composite substrate.

TABLE 1
Weight of the Composite Substrate

| | Weight | Area | Weight |
|---|---|---|---|
| Sample | (grams) | (square inches) | (g/m²) |
| 1 | 2.065 | 4 × 4 | Wt = 0.13205 grams/square inch |
| 2 | 2.292 | = 204.678 g/m² | |
| 3 | 1.982 | | |
| 4 | 1.015 | 4 × 2 | Wt = 0.12996 gram/square inch. |
| 5 | 1.025 | = 201.438 g/m² | |
| 6 | 1.080 | | |
| 7 | 1.059 | | |
| 8 | 1.023 | | |

The average weight of the composite=203 g/m².

Tensile Strength

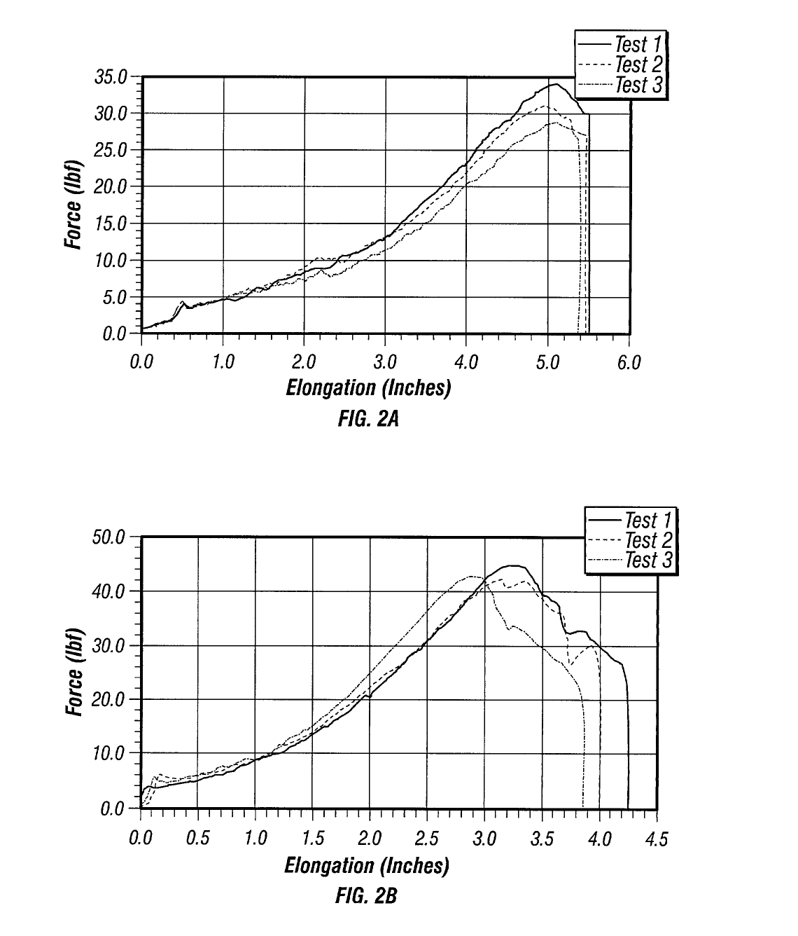

The breaking strength and the elongation of the composite substrate were measured using the “Grab” test according to the ASTM D5034 test method. The experiment was conducted in both machine and cross directions. Three repetitions were carried out in each direction. Tensile test results are given in Tables 2a and 2b. FIGS. 2A and 2B delineate the load/elongation curves for the composite fabric in cross direction and machine direction, respectively.

TABLE 2a
Tensile Strength (Cross Direction)

| | Load - Peak | Elongation - Peak | Strain - Break | Energy - Break |
|---|---|---|---|---|
| | (lbf) | (inches) | (%) | (lbf.ft) |
| Mean | 31.232 | 4.9903 | 181.56 | 6.3834 |
| SD | 2.557 | 0.0844 | 1.71 | 0.555 |

TABLE 2b
Tensile Strength (Machine Direction)

| | Load - Peak | Elongation - Peak | Strain - Break | Energy - Break |
|---|---|---|---|---|
| | (lbf) | (inches) | (%) | (lbf.ft) |
| Mean | 43.751 | 3.1213 | 134.3 | 7.5197 |
| SD | 1.276 | 0.192 | 6.31 | 0.5295 |

FX 3750 digital Elmendorf tearing tester was used to measure the tear strength of the composite in machine and cross directions using the ASTM D5734 test method. Three repetitions were carried out in both machine and cross directions. Tear strengths values for the composite substrate are given in Table 3.

TABLE 3
Tear Strength Values

| | Repeat-1 | Repeat-2 | Repeat-3 | Mean | SD |
|---|---|---|---|---|---|
| Direction | (lbf) | (lbf) | (lbf) | (lbf) | (lbf) |
| Machine | 11.100 | 13.500 | 11.600 | 12.067 | 1.266 |
| Cross | 9.150 | 9.440 | 9.160 | 9.250 | 0.165 |

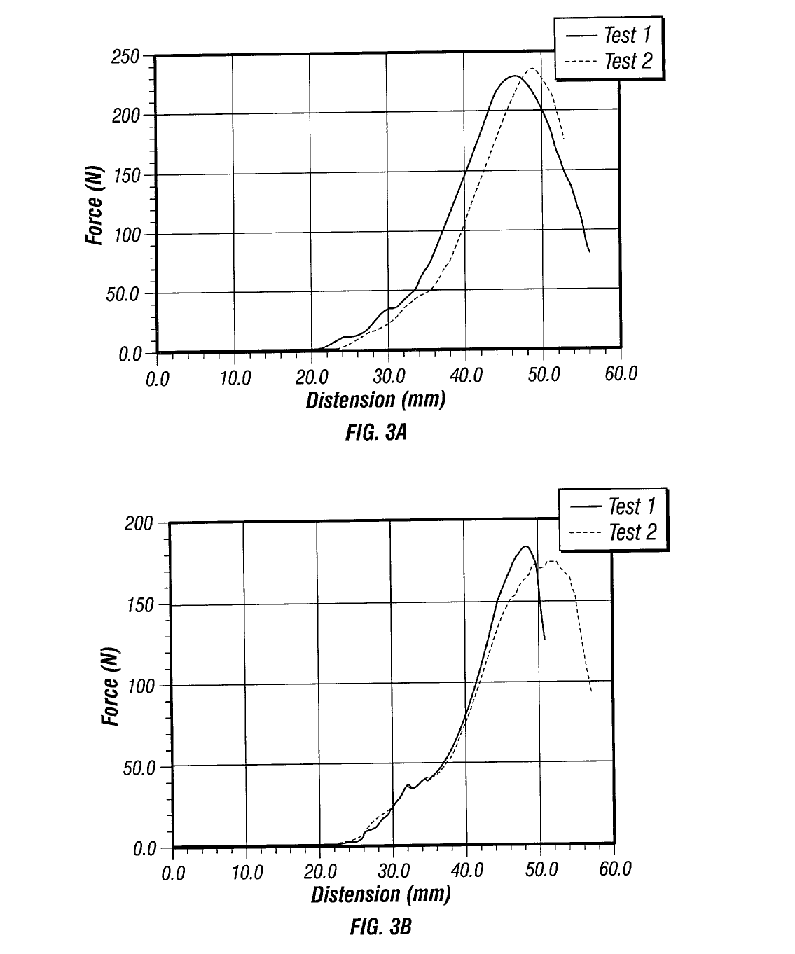

The ball burst adaptation was fitted to the SDL (CRE) tensile tester to measure the bursting strength of the composite using the ASTM D3787 test method. Two repetitions were carried out in machine and cross directions. Bursting strength results are shown in Tables 4a and 4b. FIGS. 3A and 3B delineate the bursting strength/displacement curves.

TABLE 4a
Bursting Strength Values (Machine Direction)

| | Load - | | | | Dist - |
|---|---|---|---|---|---|
| | Peak | Dist - Peak | Stress - Peak | Energy - Peak | Peak |
| | (Kgf) | (mm) | (Kgf/mm²) | (Kgf · m) | (mm) |
| Mean | 23.965 | 47.79 | 0.0019 | 225.84 | 54.99 |
| SD | 0.502 | 1.456 | 0.000 | 3.33 | 2.334 |

TABLE 4b
Bursting Strength Values (Cross Direction)

| | Load - | | | | Dist - |
|---|---|---|---|---|---|
| | Peak | Dist - Peak | Stress - Peak | Energy - Peak | Peak |
| | (Kgf) | (mm) | (Kgf/mm²) | (Kgf · m) | (mm) |
| Mean | 18.27 | 50.155 | 0.0014 | 202.80 | 54.905 |
| SD | 0.410 | 3.147 | 0.000 | 43.7 | 4.236 |

The B. C. Ames Co.'s thickness gauge was used to measure the thickness of the composite at a pressure of 3.4 psi using the ASTM D1777-60T test method. Twenty readings were taken. The thickness value was measured in one thousandth of an inch. The mean value was 41.16 (1/1000″) and the SD was 1.558. The thickness of the composite fabric was 1.045 mm.

The development of the multilayer laminated composite is to improve the “next-to-skin” comfort properties of the adsorbent layers. One of the comfort properties that influence the wearers' performance and comfort is the frictional characteristics. Therefore a small study was conducted to evaluate the frictional properties of nonwoven/woven/nonwoven composite substrate.

The sliding friction adaptation as shown in FIG. 4 was used to measure the frictional properties of the CW protection substrate. A bovine leather sledge 410 was used as a standard substrate. The area of the sledge was 20 cm². The sliding friction experiment was conducted at 6 different normal loads at a sliding speed of 500 mm/min. The minimum load used was 34.66 grams and the maximum load used was 84.66 grams. The load was incremented in step of 10 grams. Three repetitions were carried out at each normal load. The average friction force value was used to calculate the friction parameters. The frictional properties were characterized using the friction parameter “C” and the friction index “n”. In addition, the frictional properties were characterized using the friction factor “R” where, R=C/n.

FIG. 4 shows a sliding friction apparatus used to take surface friction measurements of the preferred composite substrate. The sliding friction apparatus includes bovine leather sledge 410, fabric 420, aluminum platform 430, and frictionless pulley 440.

TABLE 5
Frictional Properties of the Composite Substrate

| | | | |
|---|---|---|---|
| | Friction | Friction | Friction |
| | Parameter | Index | Factor |
| Composite Substrate | “C”[Pa] ^{1 - n} | “n” | “R” [Pa] ^{1 - n} |

5.1. Across the machine direction

| | | | |
|---|---|---|---|
| Static | 0.242 | 1.069 | 0.227 |
| Dynamic | 0.093 | 1.210 | 0.077 |
| Average | 0.157 | 1.329 | 0.118 |
| (Static + Dynamic) | | | |

5.2 Along the machine direction

| | | | |
|---|---|---|---|
| Static | 0.0124 | 1.601 | 0.007 |
| Dynamic | 0.004 | 1.726 | 0.002 |
| Average | 0.008 | 1.647 | 0.049 |
| (Static + Dynamic) | | | |

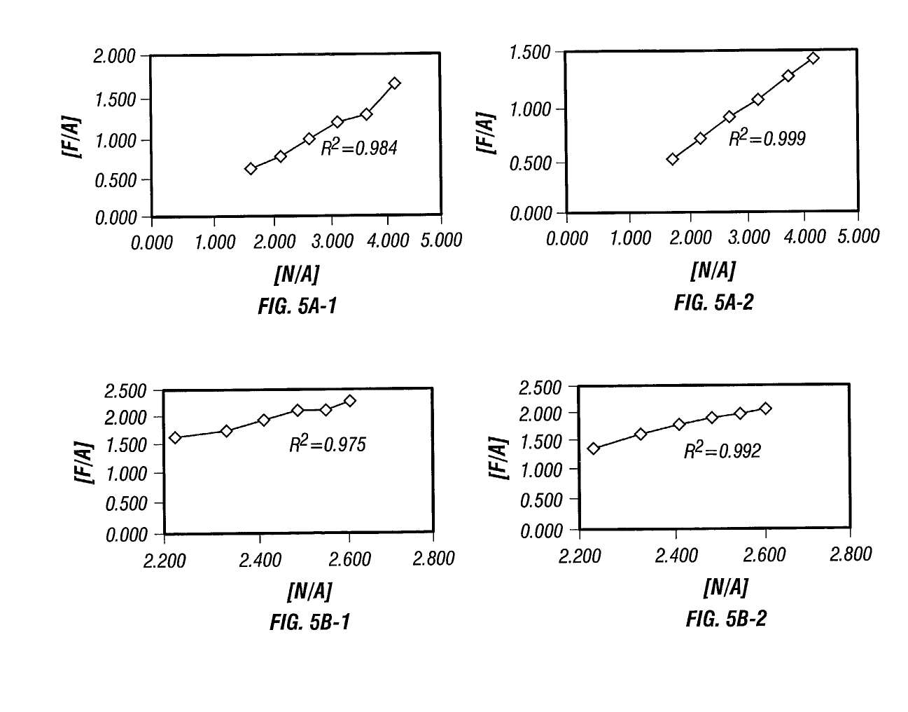

FIG. 5A shows a graph of Friction Force vs. Normal Load Relationship across the machine direction. FIG. 5B shows a graph of Friction Force vs. Normal Load Relationship along the machine direction.

As is evident from FIGS. 5a and 5b, it is clear that the relationship F/A=C(N/A)n is valid for the composite fabric developed, where F is the friction force, N is the normal applied load, A is the apparent area of contact, C is the friction parameter and n is the friction index. This also shows that characterizing the frictional properties using the frictional parameters such as “C”, “n” and “R” is logical.

Breathability is an important comfort factor and it affects the wearers' performance. Breathability is characterized based on water vapor transmission (WVT) through fabrics. WVT through the protective composite was measured using the standard ASTM E96 test method. This test was conducted at Texas Research Institute (TRI) Austin, Inc. ASTM E96 procedure was followed at 98F at 50% RH. The test duration was 22 hours. The WVT transmission rate is given in Table 6.

Breathability Studies (WVT Transmission Rate)

| Repetitions | WVT (g/m²/hr) |
|---|---|
| 1 | 400.45 |
| 2 | 367.44 |
| 3 | 354.52 |
| Mean | 374.137 |
| SD | 23.686 |

As is evident from the results, it is clear that the three-layered composite has allowed a good amount of water vapor to permeate through the layers indicating that composite substrate is highly breathable.

Imaging the Composite Substrate

Scanning electron micrograph of the cross section of the composite substrate was taken using Hitachi S500 SEM at a magnification level of 45. It is evident from the scanning micro-graph that the fibers in the nonwoven substrates interlock with the yarns of the woven middle layer at the interface. Furthermore, it is also clear that there is not much damage to the woven adsorbent layer due to needling process. From the micrograph, it is evident that the multiple needling does not result in breaking the nonwoven substrates and the woven intermediate layer. The needling method resulted in a well-integrated composite substrate having adequate physical properties.

In an examination of the cross section of the composite at higher magnification level (×500), it is clearly evident that the fibers from the nonwoven layers interlock with the filament layer in the composite. This results in a well-integrated composite substrate. Furthermore, it is also evident that there is no breakage of fibers or filaments in the composite due to the needling process at 800 strokes /min. Higher magnification SEM photograph helps to better understand the interlocking process more clearly at the interface and the looping of the polyester fibers with the activated carbon filament can be seen from the micrograph.

Chemical absorption studies were undertaken at TRI Environmental, Inc., Austin, Tex. and was carried out in two steps.

In the first step, a sample portion of the material approximately one inch square was cut from the original sheet of material. This material sample was placed in a Thermolyne 1300 furnace at a temperature of 350° C. for 2 hours. The purpose of this procedure was to bum away the polyester (Dacron) layer of the material as well as purify the activated charcoal. The result was a sample of the activated charcoal substrate approximately one inch square. This procedure helped to ensure a steady baseline for analysis. Furthermore, as the polyester layer does not contribute to the absorption mechanism, the removal of polyester fibers was thought not to affect the test result.

In the second step, the sample of the activated charcoal substrate was then placed into a TGA 951 gravimetric instrument. The challenge gas was 100 ppm Toluene in Nitrogen. The flow rate of the challenge gas was 100 mL/min. The test temperature varied between 25° C. and 30° C. (This temperature range allowed for temperatures that a user might expect to encounter while wearing the material). The material sample was tested for 8 hours of continuous contact with the challenge gas and the weight change of the sample was measured constantly for the length of the test. (The eight-hour time period was used to accommodate the traditional 8-hour workday).

Absorption Test Analysis

The material sample began showing absorption characteristics within 10 minutes of starting the test. The material sample gained weight throughout the 8-hour test. This is indicative of the material sample adsorbing the challenge gas. The material never reached an equilibrium rate of absorption. In addition, the material never reached a maximum absorption rate. This is indicative of the material never reaching a “saturated” state during the eight-hour time period. Therefore, it may be necessary to perform the test for a longer period of time to determine saturation value for the activated charcoal. This is indicative of the “activity” of the adsorbent layer. The fabric gained 13 micrograms/min on an average and never reached saturation during the testing period. This is the amount of Toluene adsorbed by the substrate on an average.

### CONCLUSIONS

A simple and new method to develop a multilayer nonwoven/woven/nonwoven composite substrate has been elaborated in this invention. The “state-of-the-art” H1 technology needlepunching nonwoven machinery has been used to develop the composite substrate. Results to-date indicate that the composite substrate has adequate physical properties, breathability and chemical absorption capabilities.

Modifications and Variations As will be recognized by those skilled in the art, the innovative concepts described in the present application can be modified and varied over a tremendous range of applications, and accordingly the scope of patented subject matter is not limited by any of the specific exemplary teachings given.

While the invention has been particularly shown and described with reference to a preferred embodiment, it will be understood by those skilled in the art that various changes in form and detail may be made therein without departing from the spirit and scope of the invention.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A chemical protective composite substrate, comprising:
a prefilter layer;
an adsorption layer, and
a base layer,
wherein the prefilter layer, adsorption layer, and base layer are combined into a composite substrate by needlepunching in a needleloom.

2. The chemical protective composite substrate of claim 1, wherein the prefilter layer is a nonwoven polyester.

3. The chemical protective composite substrate of claim 1, wherein the base layer is a nonwoven polyester.

4. The chemical protective composite substrate of claim 1, wherein the base layer is a nonwoven polyester.

5. The chemical protective composite substrate of claim 1, wherein the adsorption layer is an activated carbon woven fabric.

6. The chemical protective composite substrate of claim 1, wherein the adsorption layer is an woven fabric.

7. The chemical protective composite substrate of claim 1, wherein the adsorption layer is comprised of nanowebs.

8. The chemical protective composite substrate of claim 1, wherein the adsorption layer is comprised of fibers.

9. The chemical protective composite substrate of claim 1, wherein the needleloom operates at 800 needlestrokes per minute.

10. A method for producing a chemical protective composite substrate, comprising:
providing a prefilter fabric layer;
providing an adsorption fabric layer, and
providing a base fabric layer,
combining wherein the prefilter layer, adsorption layer, and base layer into a composite substrate by needlepunching in a needleloom.

11. The chemical protective composite substrate of claim 7, wherein the prefilter layer is a nonwoven polyester.

12. The chemical protective composite substrate of claim 7, wherein the base layer is a nonwoven polyester.

13. The chemical protective composite substrate of claim 7, wherein the base layer is a nonwoven polyester.

14. The chemical protective composite substrate of claim 7, wherein the adsorption layer is an activated carbon woven fabric.

15. The chemical protective composite substrate of claim 7, wherein the needleloom operates at 800 needlestrokes per minute.

16. The chemical protective composite substrate of claim 7, wherein the adsorption layer is an woven fabric.

17. The chemical protective composite substrate of claim 7, wherein the adsorption layer is comprised of nanowebs.

18. The chemical protective composite substrate of claim 7, wherein the adsorption layer is comprised of fibers.
